(19) United States
(12) Patent Application Publication
(10) Pub. No.: US 2016/0242102 A1
(43) Pub. Date: Aug. 18, 2016

(54) EFFICIENT METHOD TO PERFORM CELL SEARCH IN A MULTI-SUBSCRIBER IDENTITY MODULE DEVICE

(71) Applicant: QUALCOMM Incorporated, San Diego, CA (US)

(72) Inventors: Nilotpal Dhar, Hyderabad (IN); Mukesh Kumar, Hyderabad (IN)

(21) Appl. No.: 14/621,309

(22) Filed: Feb. 12, 2015

(51) Int. Cl. H04W 48/16; H04W 48/20; H04W 24/10; H04B 1/3816; H04W 72/04

(52) U.S. Cl. CPC H04W 48/16; H04B 1/3816; H04W 72/0453; H04W 24/10; H04W 48/20; H04W 88/08

(57) ABSTRACT

A method for performing a cell search that includes: identifying a first frequency used by a first base station (BS) on which a mobile communication device is camped on a first subscription; receiving one or more messages from the first BS on the first frequency; identifying a second frequency used by a second BS that is an inter-frequency neighbor of the first BS based at least in part on the one or more messages; and determining to exclude from the cell search on a second subscription at least one of the first frequency and the second frequency.

### BACKGROUND

A mobile communication device may perform a cell search in a number of scenarios. For example, after powering on, a mobile communication device may perform a cell search to identify one or more candidate base stations (BSs). In addition, a cell search may also be performed after the mobile communication device enters an out-of-service (OOS) state.

The cell search may include obtaining system parameters for each candidate BS. Based on the system parameters for the candidate BSs, the mobile communication device may subsequently perform cell selection to determine a suitable BS on which to acquire a communication network and camp.

During a conventional cell search, the full frequency band supported by a mobile communication device may be scanned. The mobile communication device may measure the strength of the each received signal on channels in the supported frequency band and identify any BS transmitting a sufficiently strong signal as a candidate BS. As such, the mobile communication device may obtain system parameters for many candidate BSs, which may prolong the cell search.

In a multi-subscriber identity module (SIM) mobile communication device, acquisition of a communication network on each subscription may be performed sequentially after the multi-SIM mobile communication device is powered on. Thus, when one subscription utilizes a shared RF chain to perform a cell search, communication network acquisition on the other subscriptions may be delayed. Consequently, the other subscriptions may be unable to commence service in a timely manner.

Moreover, a cell search on one subscription may take precedence over certain activities having a lower priority on the other subscriptions. For example, a data call on one subscription may be deferred while another subscription in an OOS state utilizes the shared RF chain to perform a cell search. As such, performing a lengthy cell search on one subscription may cause substantial interruption to activities on the other subscriptions. In addition, a lengthy cell search may also delay the resumption of service on the subscription that is in the OOS state and compromise the standby performance of that subscription.

### SUMMARY

Apparatuses and methods for efficiently performing a cell search in a multi-SIM mobile communication device are provided.

According to the various embodiments, there is provided a method for performing a cell search. The method may include: identifying a first frequency on which a mobile communication device is camped on a first subscription; receiving one or more messages from a BS at the first frequency; identifying a second frequency of at least one inter-frequency neighbor of the BS based at least in part on the one or more messages; and determining to exclude from the cell search on a second subscription at least one of the first frequency and the second frequency.

According to the various embodiments, there is provided a mobile communication device. In some embodiments, the mobile communication device may include a control unit and an RF chain.

The control unit may be configured to: identify a first frequency on which the mobile communication device is camped on a first subscription; receive one or more messages from a BS at the first frequency; identify a second frequency of at least one inter-frequency neighbor of the BS based at least in part on the one or more messages; and determine to exclude from a cell search on a second subscription at least one of the first frequency and the second frequency.

According to various embodiments, there is provided a mobile communication device. In some embodiments, the mobile communication device may include: means for identifying a first frequency used by a first BS on which a mobile communication device is camped on a first subscription; means for receiving one or more messages from the first BS on the first frequency; means for identifying a second frequency used by a second BS that is an inter-frequency neighbor of the first BS based at least in part on the one or more messages; and means for determining to exclude from the cell search on a second subscription at least one of the first frequency and the second frequency.

According to various embodiments, there is provided a non-transitory computer readable medium. In some embodiments, the non-transitory computer readable medium may have stored thereon instructions for causing one or more processors to perform operations comprising: identifying a first frequency on which a mobile communication device is camped on a first subscription; receiving one or more messages from a BS at the first frequency; identifying a second frequency of at least one inter-frequency neighbor of the BS based at least in part on the one or more messages; and determining to exclude from the cell search on a second subscription at least one of the first frequency and the second frequency.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a diagram illustrating a network environment for various embodiments;

FIG. 2 is a block diagram illustrating a mobile communication device according to various embodiments;

FIG. 3 illustrates the allocation of a frequency band applicable to various embodiments;

FIG. 4 is a flowchart illustrating a process for performing a cell search according to various embodiments; and

FIG. 5 is a flowchart illustrating a process for performing a cell search according to various embodiments.

### DETAILED DESCRIPTION

While a number of embodiments are described herein, these embodiments are presented by way of example only, and are not intended to limit the scope of protection. The apparatuses and methods described herein may be embodied in a variety of other forms. Furthermore, various omissions, substitutions, and changes in the form of the example apparatuses and methods described herein may be made without departing from the scope of protection.

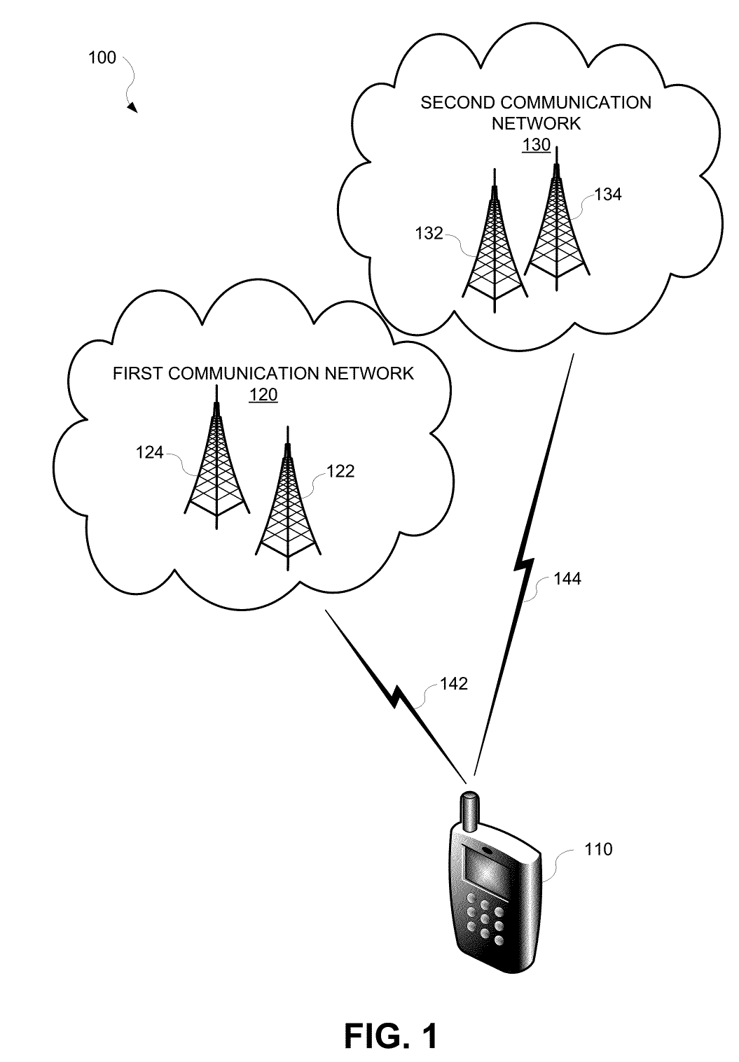

FIG. 1 is a diagram illustrating a network environment 100 for various embodiments. Referring to FIG. 1, a mobile communication device 110 may communicate with a first communication network 120 using a first subscription 142.

In various embodiments, the mobile communication device 110 may be a multi-SIM mobile communication device. Thus, in addition to the first communication network 120, the mobile communication device 110 may also communicate with at least one other communication network. For example, the mobile communication device 110 may communicate with a second communication network 130 using a second subscription 144. In various embodiments, the first communication network 120 and the second communication network 130 may each be, for example, but not limited to, a wireless or mobile communication network.

The first communication network 120 may include a plurality of BSs including, for example, but not limited to, a first BS 122 and a second BS 124. The second communication network 130 may also include a plurality of BSs, including, for example, but not limited to, a third BS 132 and a fourth BS 134. A person having ordinary skill in the art can appreciate that the network environment 100 may include any number of communication networks, mobile communication devices, and BSs without departing from the scope of the present inventive concept.

The mobile communication device 110 may have just been powered on and may attempt to acquire the first communication network 120 on the first subscription 142. Alternately, the mobile communication device 110 may have previously acquired the first communication network 120 but may be in an OOS state on the first subscription 142. For instance, the mobile communication device 110 may encounter a system loss or a system access failure on the first subscription 142.

As a result, the mobile communication device 110 may perform a cell search on the first subscription 142 to identify one or more candidate BSs. The mobile communication device 110 may select a suitable BS from the candidate BSs on which to acquire the first communication network 120 and camp. For example, the mobile communication device 110 may perform a cell search and identify the first BS 122 and the second BS 124 as candidate BSs. At the same time, the mobile communication device 110 may have acquired the second communication network 130 and may be camped on the third BS 132 or on the fourth BS 134.

Alternately, the mobile communication device 110 may have acquired the first communication network 120 and may be camped on the first BS 122 or the second BS 124. Meanwhile, the mobile communication device 110 may perform a cell search on the second subscription 144 and identify the third BS 132 and the fourth BS 134 as candidate BSs. For example, the mobile communication device 110 may perform a cell search on the second subscription 144 in order to acquire the second communication network 130 after the mobile communication device 110 was powered on. The mobile communication device 110 may also perform a cell search on the second subscription 144 if the mobile communication device 110 is in an OOS state on the second subscription 144.

A person having ordinary skill in the art can appreciate that a cell search on the first subscription 142 may be performed independently of a cell search on the second subscription 144. Furthermore, the mobile communication device 110 may perform a cell search on the first subscription 142 and a cell search on the second subscription 144 in the same or a different manner.

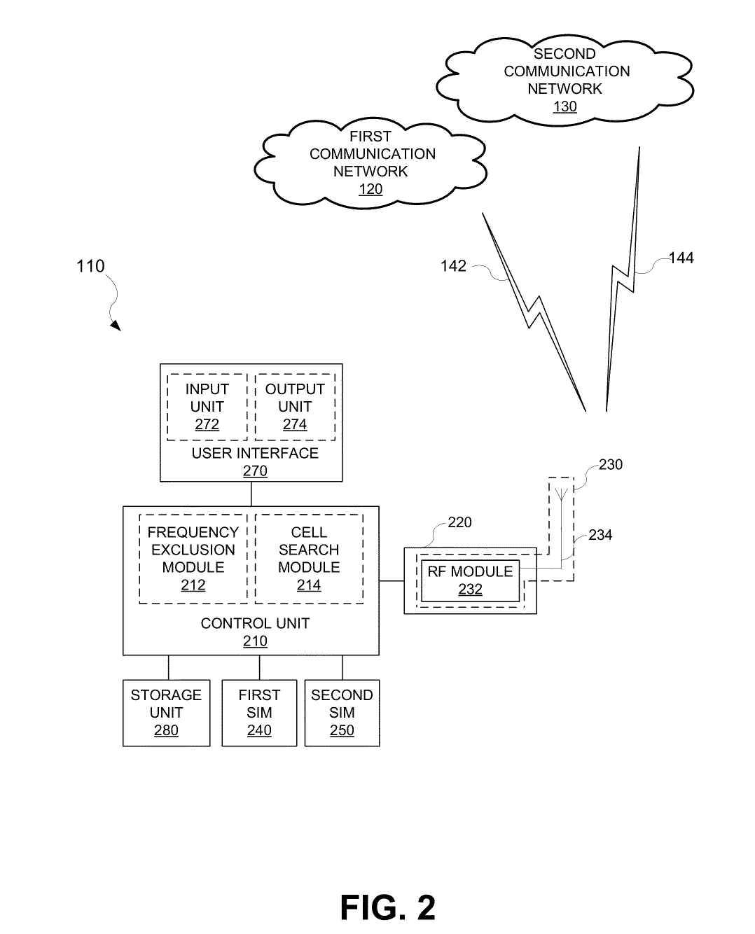

FIG. 2 is a block diagram illustrating a mobile communication device (e.g., 110) according to various embodiments. Referring to FIGS. 1 and 2, in various embodiments, the mobile communication device 110 may include a control unit 210, a communication unit 220, a first SIM 240, a second SIM 250, a user interface 270, and storage unit 280.

In various embodiments, the mobile communication device 110 may be any device capable of wirelessly communicating with one or more communication networks. In various embodiments, the mobile communication device 110 may be, for example, but not limited to, a smartphone, a tablet PC, or a laptop computer.

In various embodiments, the communication unit 220 may include an RF chain 230. The RF chain 230 may include, for example, but not limited to, an RF module 232 and an antenna 234. Although the mobile communication device 110 is shown to include a single communication unit (e.g., communication unit 220), a person having ordinary skill in the art can appreciate that the mobile communication device 110 may include additional communication units without departing from the scope of the present inventive concept.

In various embodiments, the first SIM 240 may associate the communication unit 220 with the first subscription 142 on the first communication network 120 while the second SIM 250 may associate the communication unit 220 with the second subscription 144 on the second communication network 130.

In various embodiments, the first communication network 120 and the second communication network 130 may be associated with different mobile network operators (MNOs). Additionally, in various embodiments, the first communication network 120 and the second communication network 130 may each support the same or different radio access technologies (RATs), including but not limited to Wideband Code Division Multiple Access (WCDMA), Global System for Mobile communications (GSM), Long Term Evolution (LTE), and Time Division-Synchronous Code Division Multiple Access (TD-SCDMA).

In various embodiments, the user interface 270 may include an input unit 272. In some embodiments, the input unit 272 may be, for example, but not limited to, a keyboard or a touch panel. In various embodiments, the user interface 270 may include an output unit 274. In some embodiments, the output unit 274 may be, for example, but not limited to, a liquid crystal display (LCD) or a light emitting diode (LED) display. A person having ordinary skill in the art will appreciate that other types or forms of input and output units may be used without departing from the scope of the present inventive concept.

In various embodiments, the control unit 210 may be configured to control the overall operation of the mobile communication device 110 including controlling the functions of the communication unit 220. In various embodiments, the control unit 210 may include a frequency exclusion module 212 and a cell search module 214. In various embodiments, the control unit 210 may be, for example, but not limited to, a microprocessor or a microcontroller.

In various embodiments, the storage unit 280 may be configured to store application programs, application data, and user data. Furthermore, in various embodiments, at least some of the application programs stored at the storage unit 280 may be executed by the control unit 210 for the operation of the mobile communication device 110.

In various embodiments, the mobile communication device 110 may be a multi SIM multi standby (MSMS) mobile communication device. However, a person having ordinary skill in the art can appreciate that the mobile communication device 110 may be a multi SIM multi active (MSMA) mobile communication device without departing from the scope of the present inventive concept.

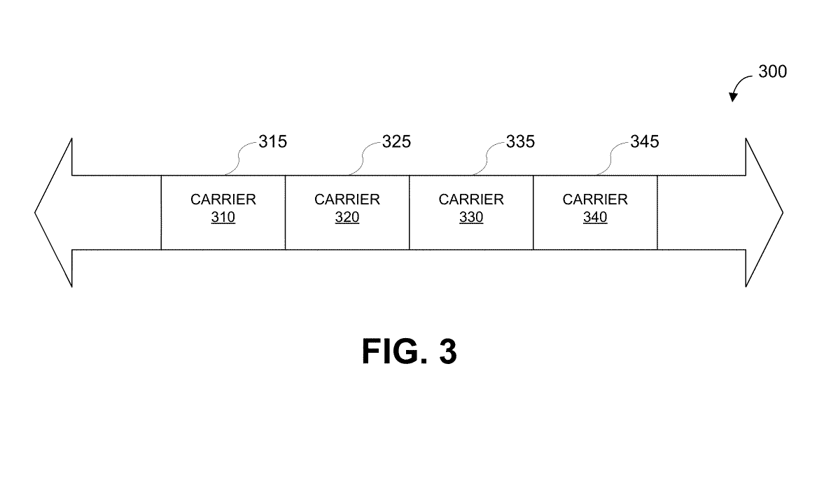

In various embodiments, the control unit 210 may selectively exclude certain frequencies when performing a cell search on the first subscription 142. For example, as the control unit 210 performs a cell search over a frequency band (e.g., 300 in FIG. 3), the control unit 210 may not examine certain excluded frequencies.

The first communication network 120 and the second communication network 130 may be associated with different MNOs. Thus, the control unit 210 may be configured to exclude from a cell search on the first subscription 142 frequencies that are assigned to BSs in the second communication network 130. For instance, the control unit 210 may exclude from the cell search on the first subscription 142 the frequency of the carrier used by the BS on which the mobile communication device 110 is camped on the second subscription 144. Moreover, the control unit 210 may exclude from the cell search frequencies used by one or more BSs that are determined to be inter-frequency neighbors of the BS on which the mobile communication device 110 is camped on the second subscription 144. For example, an inter-frequency neighbor of a BS may be a nearby BS that is assigned to use a different frequency on a same subscription.

In various embodiments, the control unit 210 may be further configured to exclude frequencies that are assigned to BSs in the first communication network 120 may also be excluded from a cell search on the second subscription 144.

FIG. 3 illustrates an allocation of a frequency band 300 applicable to various embodiments. Referring to FIGS. 1-3, the frequency band 300 may include multiple sub-bands that are each allocated to a different carrier. For instance, the frequency band 300 may include, for example, but not limited to, a first sub-band 315, a second sub-band 325, a third sub-band 335, and a fourth sub-band 345. The first sub-band 315 may be allocated to a first carrier 310, the second sub-band 325 may be allocated to a second carrier 320, the third sub-band 335 may be allocated to a third carrier 330, and the fourth sub-band 345 may be allocated to a fourth carrier 340.

In various embodiments, the mobile communication device 110 may be configured to support the frequency band 300. For instance, the mobile communication device 110 may use the RF chain 230 to tune to one or more sub-bands in the frequency band 300 including, for example, but not limited to, the first sub-band 315, the second sub-band 325, the third sub-band 335, and the fourth sub-band 345.

For clarity and convenience, the frequency band 300 is shown to include four sub-bands allocated to different carriers. The carriers may be assigned to BSs that are in two communication networks associated with different MNOs. However, a person having ordinary skill in the art can appreciate that the frequency band 300 may include a different number of sub-bands without departing from the scope of the present inventive concept. Various sub-bands may be allocated to carriers in the same or a different manner without departing from the scope of the present inventive concept. Moreover, carriers in the frequency band 300 may be assigned to additional MNOs in the same or a different manner without departing from the scope of the present inventive concept.

The first communication network 120 and the second communication network 130 may be associated with different MNOs. Thus, different carriers may be assigned to the BSs in the first communication network 120 than the carriers assigned to the BSs in the second communication network 130. For instance, the first carrier 310 and the second carrier 320 may be assigned to BSs in the first communication network 120, including, for example, but not limited to, the first BS 122 and the second BS 124. Meanwhile, the third carrier 330 and the fourth carrier 340 may be assigned to BSs in the second communication network 130, including, for example, but not limited to, the third BS 132 and the fourth BS 134.

The control unit 210 may perform a cell search on the first subscription 142 to identify one or more candidate BSs in the first communication network 120. The third carrier 330 and the fourth carrier 340 may be assigned to BSs in the second communication network 130. The second communication network 130 may be associated with a different MNO. Thus, neither the first BS 122 nor the second BS 124 may be assigned to use the third carrier 330 and the fourth carrier 340. Instead, the first BS 122 may be assigned to use the first carrier 310 and the second BS 124 may be assigned to use the second carrier 320.

As such, although the mobile communication device 110 may support the entire frequency band 300, the control unit 210 may exclude the frequencies of the third carrier 330 and the fourth carrier 340 from the cell search performed on the first subscription 142. Similarly, the control unit 210 may exclude the frequencies of the first carrier 310 and the second carrier 320 when the control unit 210 performs a cell search on the second subscription 144 to identify one or more candidate BSs in the second communication network 130.

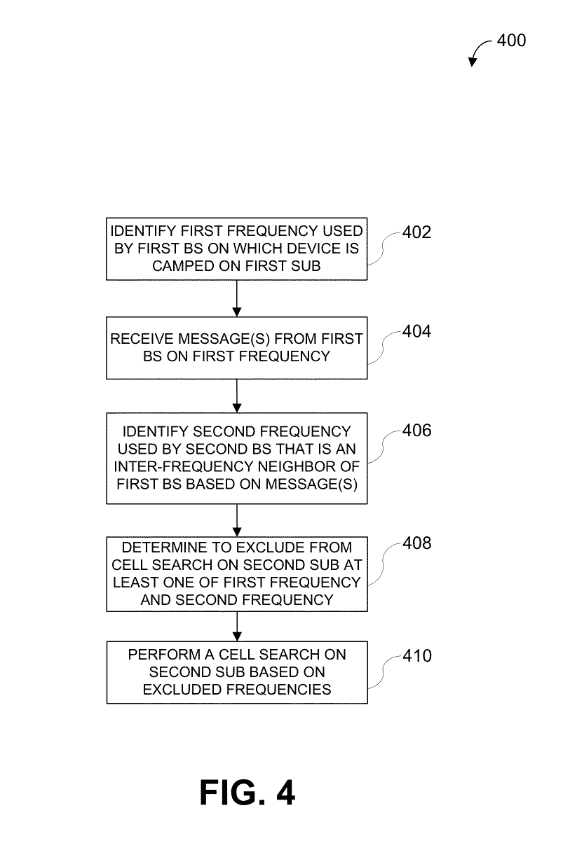

FIG. 4 is a flowchart illustrating a process 400 for performing a cell search according to various embodiments. With reference to FIGS. 1-4, in various embodiments, the process 400 may be performed by the control unit 210, for example, by the frequency exclusion module 212.

The control unit 210 may identify a first frequency used by a first BS on which a mobile communication device is camped on a first subscription (402). For instance, the mobile communication device 110 may be camped on the frequency of the first carrier 310 assigned to the first BS 122.

The control unit 210 may receive one or more messages (e.g., SI messages) from the first BS on the first frequency (404). For example, while the mobile communication device 110 is camped on the frequency of the first carrier 310, the control unit 210 may receive SI messages from the first BS 122 on the frequency of the first carrier 310.

The control unit 210 may identify a second frequency used by a second BS that is an inter-frequency neighbor of the first BS based on the one or more SI messages (406). For example, one or more SI messages from the first BS 122 may indicate that the second BS 124 is an inter-frequency neighbor of the first BS 122. Meanwhile, the second carrier 320 may be assigned to the second BS 124. As such, the control unit 210 may identify the frequency of the second carrier 320 assigned to the second BS 124.

The control unit 210 may determine to exclude from a cell search on a second subscription at least one of the first frequency on which the mobile communication device is camped on the first subscription and the second frequency used by the inter-frequency neighbor on the first subscription 142 (408). For instance, the control unit 210 may determine to exclude from a cell search performed on the second subscription 144 the frequency of the first carrier 310 used by the first BS 122 on which the mobile communication device 110 is camped on the first subscription 142. In addition, the control unit 210 may determine to exclude from the cell search the frequency of the second carrier 320 used by the second BS 124 that is an inter-frequency neighbor on the first subscription 142.

The control unit 210 may perform a cell search on the second subscription based on the excluded frequencies (410). For example, when the control unit 210 performs a cell search on the second subscription 144 over the frequency band 300, the control unit 210 may exclude the frequency of the first carrier 310 and/or frequency of the second carrier 320.

For clarity and convenience, the process 400 is described with respect to the first subscription 142. However, a person having ordinary skill in the art can appreciate that the control unit 210 may also perform the process 400 with respect to the second subscription 144 instead of or in addition to the first subscription 142 without departing from the scope of the present inventive concept.

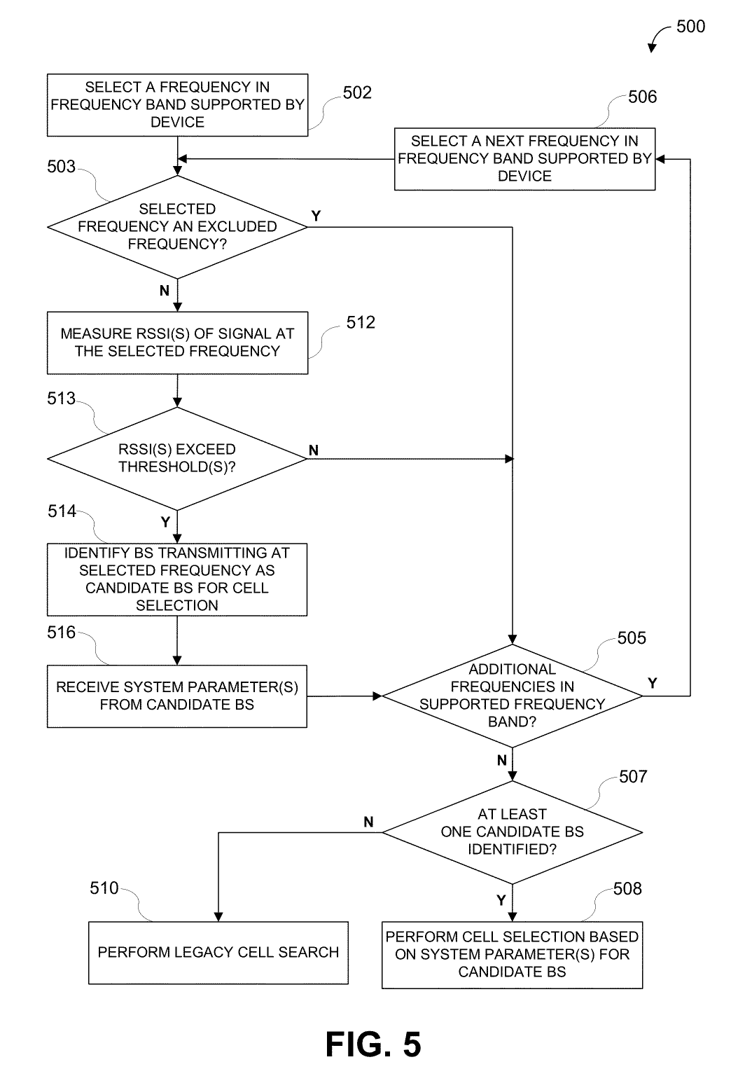

FIG. 5 is a flowchart illustrating a process 500 for performing a cell search according to various embodiments. Referring to FIGS. 1-5, in various embodiments, the process 500 may be performed by the control unit 210, for example, by the cell search module 214, and may implement operation 410 of the process 400.

In various embodiments, the control unit 210 may select one of the frequencies in a frequency band (e.g., the frequency band 300) supported by a mobile communication device (e.g., the mobile communication device 110) (502). The control unit 210 may determine whether the selected frequency is an excluded frequency (503). For instance, the mobile communication device 110 may support a particular frequency band (e.g., the frequency band 300); however, the frequency of the first carrier 310 and the frequency of the second carrier 320 may be excluded frequencies. The control unit 210 may determine whether the selected frequency is one of the first carrier 310 or the second carrier 320.

The control unit 210 may examine the frequency of every carrier in the frequency band 300 to at least determine whether each frequency is an excluded frequency. Thus, if the control unit 210 determines that the selected frequency is an excluded frequency (503-Y), the control unit 210 may determine whether there are one or more additional frequencies in the frequency band 300 supported by the mobile communication device 110 (505).

If the control unit 210 determines that there are one or more additional frequencies in the frequency band 300 (505-Y), the control unit 210 may select a next frequency in the frequency band 300 (506) and continue the process at operation 503.

Alternately, the control unit 210 may determine that the selected frequency is not an excluded frequency (503-N). As such, the control unit 210 may measure one or more received signal strength indicators (RSSIs) of a signal at the selected frequency (512). The control unit 210 may determine whether the one or more RSSIs exceed corresponding threshold(s) (513). The threshold(s) for the one or more RSSIs may be determined based on the RAT that is associated with the second subscription 144. Thus, the threshold(s) for the one or more RSSIs may correspond to a minimum energy level at which a signal of the RAT associated with the second subscription 144 may be expected to be found.

If the control unit 210 determines that the one or more RSSIs do not exceed the corresponding threshold(s) (513-N), the control unit 210 may determine whether there are one or more additional frequencies in the frequency band 300 supported by the mobile communication device 110 (505).

The control unit 210 may examine the frequency of every remaining carrier in the frequency band 300 supported by the mobile communication device 110 to at least determine whether each frequency is an excluded frequency. Thus, if the control unit 210 determines that there are one or more additional frequencies in the frequency band 300 (505-Y), the control unit 210 may select a next frequency in the frequency band 300 (506) and continue the process at operation 503.

Alternately, the control unit 210 may determine that the one or more RSSIs exceed the corresponding threshold(s) (513-Y). As such, the control unit 210 may identify the BS transmitting at the selected frequency as a candidate BS for cell selection (514). For example, the third BS 132 may transmit at the selected frequency. The control unit 210 may measure the one or more RSSIs of the signal transmitted by the third BS 132 at the selected frequency. The control unit 210 may determine whether the one or more RSSIs of the signal exceed threshold(s) corresponding to the minimum energy level at which a signal of the RAT associated with the second subscription 144 may be expected to be found. If the one or more RSSIs of the signal exceed the corresponding threshold(s), the control unit 210 may identify the third BS 132 as a candidate BS.

The control unit 210 may receive one or more system parameters from the candidate BS (516). For example, the third BS 132 may transmit one or more system parameters on the Primary Common Control Physical Channel (PCCPCH). In order to receive the system parameters for the third BS 132, the control unit 210 may synchronize the mobile communication device 110 (e.g., the RF chain 230) to the timing of the third BS 132 and decode the data transmitted by the third BS 132 on the PCCPCH.

Once the control unit 210 receives system parameters from one candidate BS, the control unit 210 may continue the process at operation 505. The control unit 210 may examine the frequency of every remaining carrier in the frequency band 300 supported by the mobile communication device 110 to at least determine whether each frequency is an excluded frequency. Thus, the control unit 210 may determine whether there are one or more additional frequencies in the frequency band 300 supported by the mobile communication device 110 (505).

If the control unit 210 determines that there are one or more additional frequencies in the frequency band 300 (505-Y), the control unit 210 may select a next frequency in the frequency band 300 supported by the mobile communication device 110 (506) and continue the process at operation 503.

If the control unit 210 determines that there are no additional frequencies in the frequency band 300 supported by the mobile communication device 110 (505-N), the control unit 210 may continue the process at operation 507. For example, the control unit 210 may determine that there are no additional frequencies in the frequency band 300 when the control unit 210 has examined the frequency of every carrier in the frequency band 300. For the frequency of each carrier in the frequency band 300, the control unit 210 may at least determine whether the frequency is an excluded frequency.

The control unit 210 may determine that the control unit 210 has identified at least one candidate BS (507-Y) and may perform cell selection based on the system parameters for the candidate BS (508). For instance, the control unit 210 may examine the frequency of every carrier in the frequency band 300 and identify at least the third BS 132 as a candidate BS. The control unit 210 may perform cell selection on the second subscription 144 based on the system parameters for the candidate BSs (e.g., the third BS 132).

However, if the control unit 210 determines that the control unit 210 has not identified at least one candidate BS (507-N), the control unit 210 may perform legacy cell search (510).

For clarity and convenience, the process 400 is described with respect to the second subscription 144. However, a person having ordinary skill in the art can appreciate that the control unit 210 may also perform the process 400 with respect to the first subscription 142 instead of or in addition to the second subscription 144 without departing from the scope of the present inventive concept.

The accompanying claims and their equivalents are intended to cover such forms or modifications as would fall within the scope and spirit of the protection. For instance, the example apparatuses, methods, and systems disclosed herein may be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, modules, and circuits described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for performing a cell search, comprising:
identifying a first frequency used by a first base station (BS) on which a mobile communication device is camped on a first subscription;
receiving one or more messages from the first BS on the first frequency;
identifying a second frequency used by a second BS that is an inter-frequency neighbor of the first BS based at least in part on the one or more messages; and
determining to exclude from the cell search on a second subscription at least one of the first frequency and the second frequency.

2. The method of claim 1, wherein the first subscription is associated with a first mobile network operator (MNO) and the second subscription is associated with a second MNO.

3. The method of claim 1, wherein the one or more messages received from the first BS includes at least one system information (SI) message.

4. The method of claim 1, further comprising performing the cell search on the second subscription based at least in part on the excluded frequencies.

5. The method of claim 4, wherein the excluded frequencies are not searched as part of the cell search on the second subscription.

6. The method of claim 4, wherein performing the cell search comprises:
selecting a frequency in a frequency band supported by the mobile communication device;
determining whether the selected frequency is an excluded frequency; and
in response to a determination that the selected frequency is an excluded frequency, determining whether there are one or more additional frequencies in the frequency band supported by the mobile communication device.

7. The method of claim 6, further comprising:
in response to a determination that there are one or more additional frequencies in the frequency band supported by the mobile communication device:
selecting a next frequency in the frequency band supported by the mobile communication device; and
determining whether the selected frequency is an excluded frequencies.

8. The method of claim 6, further comprising in response to a determination that the selected frequency is not an excluded frequencies:
measuring one or more received signal strength indicators (RSSIs) of a signal at the selected frequency; and
determining whether the one or more RSSIs exceed one or more corresponding thresholds.

9. The method of claim 8, further comprising in response to a determination that the one or more RSSIs do not exceed one or more corresponding thresholds:
determining whether there are one or more additional frequencies in the frequency band supported by the mobile communication device; and
in response to a determination that there are one or more additional frequencies in the frequency band supported by the mobile communication device:
selecting a next frequency in the frequency band supported by the mobile communication device; and
determining whether the selected frequency is an excluded frequency.

10. The method of claim 8, further comprising in response to a determination that the one or more RSSIs exceed one or more corresponding thresholds:
identifying a BS transmitting at the selected frequency as a candidate BS for cell selection;
receiving one or more system parameters from the candidate BS.

11. The method of claim 10, further comprising:
determining whether there are one or more additional frequencies in frequency band supported by the mobile communication device; and
in response to a determination that there are no additional frequencies in the frequency band supported by the mobile communication device, determining whether at least one candidate BS has been identified.

12. The method of claim 11, further comprising in response to a determination that at least one candidate BS has been identified, performing cell selection based at least in part on system parameters for the candidate BS.

13. A mobile communication device, comprising:
a radio frequency (RF) chain; and
a control unit configured to:
identify a first frequency used by a first base station (BS) on which the mobile communication device is camped on a first subscription;
receive one or more messages from the first BS on the first frequency;
identify a second frequency used by a second BS that is an inter-frequency neighbor of the first BS based at least in part on the one or more messages; and
determine to exclude from a cell search on a second subscription at least one of the first frequency and the second frequency.

14. The mobile communication device of claim 13, wherein the first subscription is associated with a first mobile network operator (MNO) and the second subscription is associated with a second MNO.

15. The mobile communication device of claim 13, wherein the one or more messages received from the first BS includes at least one system information (SI) message.

16. The mobile communication device of claim 13, wherein the control unit is further configured to perform the cell search on the second subscription based at least in part on the excluded frequencies.

17. The mobile communication device of claim 16, wherein the excluded frequencies are not searched as part of the cell search performed by the control unit on the second subscription.

18. The mobile communication device of claim 16, wherein to perform the cell search, the control unit is configured to:
select a frequency in a frequency band supported by the mobile communication device;
determine whether the selected frequency is an excluded frequency; and
in response to a determination that the selected frequency is an excluded frequency, determine whether there are one or more additional frequencies in the frequency band supported by the mobile communication device.

19. The mobile communication device of claim 18, wherein in response to a determination that there are one or more additional frequencies in the frequency band supported by the mobile communication device, the control unit is further configured to:
select a next frequency in the frequency band supported by the mobile communication device; and
determine whether the selected frequency is an excluded frequency.

20. The mobile communication device of claim 18, wherein in response to a determination that the selected frequency is not an excluded frequency, the control unit is further configured to:
measure one or more received signal strength indicators (RSSIs) of a signal at the selected frequency; and
determine whether the one or more RSSIs exceed one or more corresponding thresholds.

21. The mobile communication device of claim 20, wherein in response to a determination that the one or more RSSIs do not exceed one or more corresponding thresholds, the control unit is configured to:
determine whether there are one or more additional frequencies in the frequency band supported by the mobile communication device; and
in response to a determination that there are one or more additional frequencies in the frequency band supported by the mobile communication device:
select a next frequency in the frequency band supported by the mobile communication device; and
determine whether the selected frequency is an excluded frequency.

22. The mobile communication device of claim 20, wherein in response to a determination that the one or more RSSIs exceed one or more corresponding thresholds, the control unit is configured to:
identify a BS transmitting at the selected frequency as a candidate BS for cell selection; and
receive one or more system parameters from the candidate BS.

23. The mobile communication device of claim 22, wherein the control unit is further configured to:
determine whether there are one or more additional frequencies in the frequency band supported by the mobile communication device; and
in response to a determination that there are no additional frequencies in the frequency band supported by the mobile communication device, determine whether at least one candidate BS has been identified.

24. The mobile communication device of claim 23, wherein in response to a determination that at least one candidate BS has been identified, the control unit is configured to perform cell selection based at least in part on system parameters for the candidate BS.

25. A mobile communication device, comprising:
means for identifying a first frequency used by a first base station (BS) on which the mobile communication device is camped on a first subscription;
means for receiving one or more messages from the first BS on the first frequency;
means for identifying a second frequency used by a second BS that is an inter-frequency neighbor of the first BS based at least in part on the one or more messages; and
means for determining to exclude from a cell search on a second subscription at least one of the first frequency and the second frequency

26. A non-transitory computer readable medium having stored thereon instructions for causing one or more processors to perform operations comprising:
identifying a first frequency used by a first base station (BS) on which a mobile communication device is camped on a first subscription;
receiving one or more messages from the first BS on the first frequency;
identifying a second frequency used by a second BS that is an inter-frequency neighbor of the first BS based at least in part on the one or more messages; and
determining to exclude from the cell search on a second subscription at least one of the first frequency and the second frequency.
